(19) United States
(12) Patent Application Publication
(10) Pub. No.: US 2014/0046549 A1
(43) Pub. Date: Feb. 13, 2014

(54) Method for compensating for a disturbance yaw moment in a vehicle having at least two wheel-individual drives

(71) Applicant: Andreas Erban, Loechgau (DE)

(72) Inventor: Andreas Erban, Loechgau (DE)

(21) Appl. No.: 13/984,101

(22) PCT Filed: Jan. 31, 2012
(86) PCT No.: PCT/EP12/51503

§ 371 Date: Oct. 21, 2013

(30) Foreign Application Priority Data
Feb. 7, 2011 (DE) 10 2011 003 693.8

(51) Int. Cl. B62D 11/04

(52) U.S. Cl. CPC B62D 11/04
USPC 701/43

(57) ABSTRACT

A device for compensating for a disturbance yaw moment in a vehicle having at least two wheel-individual drives is described. In particular in vehicles having multiple wheel-individual electric drives, wear or heavy use may result in a defect of a single drive. Since this drive is coupled to a single wheel of the vehicle, a strong disturbance yaw moment may be generated thereby which may result in the vehicle breaking away if countermeasures are not taken. It is provided to compensate for the disturbance yaw moment at least partially by effectuating a compensation yaw moment by retarding one or multiple of the other wheels of the vehicle in a targeted manner, when an event is detected which indicates a disturbance yaw moment of the vehicle and in which one wheel of the vehicle is excessively retarded due to a defect on a wheel-individual drive assigned to the wheel.

### FIELD OF THE INVENTION

The present invention relates to a device for compensating for a disturbance yaw moment in a vehicle having at least two wheel-individual drives. The present invention furthermore relates to a vehicle equipped with such a device as well as a computer program to enable a software-controllable device to carry out the functions of the device according to the present invention.

### BACKGROUND INFORMATION

In motor vehicles, it is a basic safety need to avoid an uncontrolled breakaway or skidding of the vehicle to the greatest possible extent.

In conventional motor vehicles, driving situations which are difficult to control often result from maneuvering measures by the driver, e.g., by excessive braking or steering, which are not adequate for the situation. To be able to maintain control of the vehicle in such situations, assistance systems such as ABS (anti-lock braking system) and ESP (electronic stability program) were developed in which an angular velocity of the individual wheels is monitored with the aid of suitable wheel sensors and it is accomplished, if necessary, with the aid of the wheel-individual brakes or by redirecting the drive force provided by the engine to individual wheels that individual wheels are retarded or accelerated in such a way that a yaw moment of the vehicle may be counteracted.

In particular in electric and hybrid vehicles, wheel-individual drives are increasingly used. Here, wheels on opposite sides of the vehicle are no longer driven via a common drive, if necessary by the interposition of transmissions and differentials, as is the case in conventional vehicles. Instead, individual wheels of the vehicle each have their own drive assigned to them. Such wheel-individual drives may be implemented as electric machines, for example, which drive the wheel assigned to them via a shaft or which may be integrated directly into the wheel.

### SUMMARY OF THE INVENTION

Now, in vehicles which are equipped with multiple wheel-individual drives, other reasons may occur which are due to the malfunctions of the vehicle itself, in addition to the conventionally considered reasons for a breakaway of the vehicle, which are mostly due to the maneuvering measures of the driver or to the road conditions. For example, it is possible that a very strong unintentional disturbance yaw moment acts on the vehicle in the case of a potentially serious malfunction of a wheel-individual drive such as in the case of a blocked wheel-individual drive. The driver may be confused thereby and possibly lose control of the vehicle.

Therefore, a method and a device for carrying out such a method are to be described using which the impact of a vehicle-related strong disturbance yaw moment is compensated for at least partially in a vehicle having multiple wheel-independent drives and thus the driver is assisted in maintaining control of his/her defective vehicle more easily.

According to one first aspect of the present invention, a device for compensating for a disturbance yaw moment in a vehicle having at least two wheel-individual drives is proposed, the device being configured to carry out a method including the following steps: an event is initially to be detected which indicates a disturbance yaw moment of the vehicle and in which one wheel of the vehicle is excessively retarded due to a defect on a wheel-individual drive assigned to the wheel. Such events indicating a disturbance yaw moment may be different in nature and may thus also be detected in different ways, as will be described in detail below. As soon as such an event is detected, a compensation yaw moment compensating for the disturbance yaw moment of the vehicle at least partially is supposed to be effectuated by retarding one or multiple of the other wheels of the vehicle in a targeted manner.

The method step of retarding at least one of the wheels, which are not affected by the defective wheel-individual drive, to effectuate the compensation yaw moment may be carried out in such a way that a force Fx_{comp} applied to the vehicle by the wheel(s) retarded in a targeted manner is essentially equal to a force Fx_{interference} applied to the vehicle by the wheel retarded by the defective wheel-individual drive (Fx_{comp}≈Fx_{interference}). “Essentially equal” may mean in this context that FX_{comp} is at least similarly strong compared to Fx_{interference} to the extent that, taking into account the fact that FX_{comp} attacks at a different place of the vehicle, which may be opposite that of the wheel affected by the defective wheel-individual drive, the yaw moment applied to the vehicle by FX_{interference} is at least compensated for by Fx_{comp} strongly enough to counteract a breakaway of the vehicle sufficiently strongly, so that a driver is still able to control the vehicle.

The retardation for effectuating the compensation yaw moment may be carried out in such a way that a brake slip on the retarded wheel(s) remains smaller than a predefinable limiting value. In other words, in the case of a defect of a wheel-individual drive, at least one of the wheels which are not affected by the defect is to be decelerated in a targeted manner to effectuate the compensation yaw moment, but this deceleration is to be carried out carefully enough to prevent an excessive brake slip or, in the worst case, a complete blockage of the wheel(s) from occurring on the wheel(s) decelerated in a targeted manner. By keeping the brake slip on the wheel(s) decelerated in a targeted manner within limits, it may be ensured that a cornering grip potential of this wheel remains sufficiently intact to not further endanger a maneuverability of the vehicle by excessive deceleration of the wheels which are not affected by the defective wheel-individual drive.

To effectuate the compensation yaw moment, the wheel(s), which are to be retarded in a targeted manner, may be decelerated, for example, by activating a wheel-individual brake and/or a wheel-individual drive operated in generator mode in a retarding manner.

In order to recognize when a vehicle is at risk of breaking away due to a defect on a wheel-individual drive, an event indicating a disturbance yaw moment of the vehicle may be detected in various ways.

For example, the affected wheel's ability to roll may be checked. In other words, it may be monitored continuously and for every driven wheel of the vehicle, whether the particular wheel is able to roll freely. For this purpose, it is, for example, initially ensured that the particular wheel is not acted upon by forces of an assigned brake or an assigned wheel-individual drive in a targeted manner at least for a short time period, and subsequently it may be checked whether the wheel rotates at a speed which corresponds to the instantaneous speed of the vehicle. If it is recognized during such a check that the wheel's ability to roll is impaired or the wheel is even blocked, it may be assumed that a defect is present on the wheel or the wheel-individual drive connected to the wheel, which may then be detected as an event indicating a disturbance yaw moment of the vehicle.

Alternatively, a respective wheel-individual drive may be checked continuously and separately for every driven wheel to determine whether this drive is defective and thus could apply a disturbance yaw moment to the vehicle. A defect may, for example, be recognized when the wheel slip of the defective electric wheel drive deviates extremely (e.g., the wheel blocks) from the wheel slip of the other wheel drives over a prolonged period of time at a corresponding vehicle speed, although wheel-individual interventions by, for example, an ABS or an ESP regulating system have not been carried out.

While information regarding other components of the vehicle such as information regarding a wheel-individual braking operation, a wheel-individual acceleration operation, and wheel-individual yaw rates must in principle be present for the checking of the individual wheels' ability to roll, in order to be able to indirectly recognize based on this information that one wheel is retarded unintentionally due to a defect, such a defect may be directly recognized by checking the wheel-individual drive. The wheel-individual drive may, for example, be checked as to whether its electrical properties correspond to that of an intact drive. In the case of a defect of a drive, characteristic properties of the drive generally change, which may be used to detect an event indicating a disturbance yaw moment of the vehicle. It may, for example, be recognized when the measured rotational speed of the defective electric wheel drive deviates significantly (e.g., blocking rotational speed=0) from the rotational speeds of the other wheel drives over a prolonged period of time outside of the starting range, although wheel-individual interventions by an ABS or an ESP, for example, regulating system have not been carried out.

As another possibility of detecting the event indicating a disturbance yaw moment of the vehicle, it may be checked whether it is possible to release again an excessively retarded or, in the extreme case, blocked, wheel. In other words, when it is detected by continuously monitoring the yaw rates of the individual wheels that one of the wheels is excessively retarded or blocked, it may, for example, be tried to see whether it is possible to put this wheel back into a normally rolling state, for example, by releasing the wheel-individual brake or by targeted acceleration using the wheel-individual drive. If this is not the case, it may be assumed that the wheel is retarded unintentionally due to a defect and this may be detected as an event indicating a disturbance yaw moment of the vehicle.

The above-mentioned possibilities of detecting the event indicating a disturbance yaw moment of the vehicle may require continuous monitoring of the vehicle components. For this purpose, sensors of an ESP system may be used, for example, which continuously deliver information regarding instantaneous yaw rates of the vehicle wheels.

Alternatively, the occurrence of a disturbance yaw moment acting on the vehicle may also be recognized with the aid of acceleration sensors which detect when accelerations act on the vehicle which are untypical for the controlled vehicle state. In such a case, it may then be checked whether the disturbance yaw moment has been triggered by external conditions, e.g., by maneuvering measures of the driver which are not adequate for the situation or by road conditions, or whether the disturbance yaw moment is due to a defect of a wheel-individual drive. In the latter case, a breakaway of the vehicle may be counteracted by effectuating a corresponding compensation yaw moment, as described above.

The targeted retardation of one or multiple wheels of the vehicle which are not affected by the defective wheel-individual drive may take place at a varying deceleration torque. The deceleration operation should be carried out in such a way that a typical responsiveness of a driver of the vehicle is taken into account. For example, the vehicle or the wheels may be initially decelerated in such a way that a sufficient compensation yaw moment is effectuated. In this way, it may initially be achieved that the vehicle is decelerated even more strongly overall, but it does not break away or skid. Such a reaction of a vehicle is usually easier to manage for a driver than a vehicle which breaks away. After the driver had time to recognize the changed behavior of his/her vehicle and to respond to it, the deceleration torque acting on the not-defective wheels may be successively reduced and thus give the driver the possibility of being able to fully control his/her vehicle, which is now defective, and to be able to respond to situations in an adequate manner. In this way, it is, for example, possible to avoid excessive deceleration of the entire vehicle carried out automatically by the device according to the present invention and thus a potential rear-end collision with following vehicles. It is furthermore proposed to automatically trigger a hazard warning light in this case to make following vehicles aware of the emergency situation of the preceding vehicle.

According to another aspect of the present invention, a vehicle is proposed having multiple wheel-individual drives, which are configured as electric machines, in particular, and a device described above according to the present invention for compensating for a disturbance yaw moment in the case of a defect of a wheel-individual drive.

According to another aspect of the present invention, a computer program is proposed which, when it is executed on a software-controllable device, e.g., a programmable control unit, of a vehicle, enables this device to operate as the device according to the present invention described above. The computer program may be stored on a computer readable medium, such as a programmable memory chip or a CD. In this way, software-controlled control units in vehicles may be subsequently programmed, for example, to carry out appropriate steps in order to counteract a disturbance yaw moment, as described above, which is effectuated by a defect of a wheel-individual drive, by effectuating a compensation yaw moment.

It is pointed out that the features and advantages of the specific embodiments of the present invention are described here partially with reference to a device and partially with reference to a method which is to be carried out by such a device. Here, it is recognizable to those skilled in the art that the described method steps may be implemented in a control device with the aid of an appropriate software, for example, and that, conversely, certain functional features of the device may be implemented in the form of software. The features described here may be combined with one another or exchanged in a way recognizable to those skilled in the art.

### BRIEF DESCRIPTION OF THE DRAWING

The FIGURE shows a wheel-individual drive using the example of an electric double motor drive including a control device according to one specific embodiment of the present invention.

### DETAILED DESCRIPTION

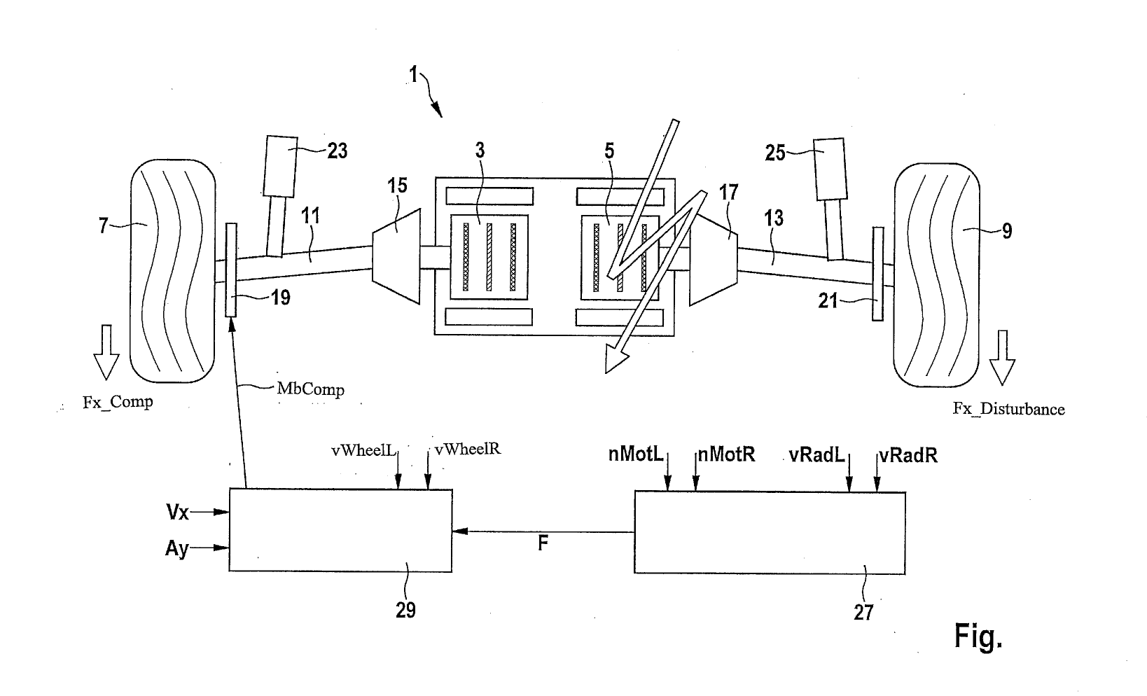

Specific embodiments of the present invention are elucidated in the following with reference to a vehicle having two wheel-individual drives in the form of an electric double motor drive, as illustrated in FIG. 1. The figure is only schematic and not true to scale.

Two separate electric motors 3, 5 which are decoupled from one another are provided in double motor drive 1. Each of motors 3, 5 is coupled for the necessary rotational speed adaptation to a wheel 7, 9 of the vehicle assigned to it via a shaft 11, 13 and, if necessary, via a transmission 15, 17 having one or multiple stages. Each wheel 7, 9 is equipped with a conventional wheel-individual braking device 19, 21, e.g., a hydraulically activated brake. Furthermore, wheel-individual spring suspensions 23, 25 may be provided.

In high-revving electric drives, such as those typically used in the form of synchronous machines for electric or hybrid vehicles, a rotor is separated only by a small air gap from a stator and may additionally be exposed to the effect of very high forces at high wheel retardations. A blocking of the rotor may, for example, occur in one of electric motors 3, 5 due to strong mechanical effects or due to material fatigue. A defect in right-hand drive motor 5 may, for example, result in the blocking of entire right-hand drive train 5, 17, 13 and, since present transmission 17 potentially does not open, in the blocking of wheel 9 connected thereto. Due to blocking wheel 9, a strong yaw moment or torque differential rotating to the right may be applied to the vehicle. Since this is a mechanical defect, the blockage of wheel 9 cannot be easily released, so that the vehicle is retarded unintentionally and an arising disturbance yaw moment may endanger the stability of the vehicle. This is illustrated in the figure by disturbance longitudinal force Fx_Stör.

By evaluating wheel and motor rotational speeds nMotL, nMotR, vWheelL, vWheelR with the aid of an assessment of the transmission behavior, a monitoring unit 27 recognizes such a dangerous situation and issues a release F for compensating for this disturbance yaw moment at least partially. This is illustrated in the figure by a compensation longitudinal force Fx_{—comp} on wheel 7 which is not impaired by defective motor 5.

Compensation yaw moment MbComp directed in the opposite direction is computed in compensator 29 as soon as it has been determined by monitoring unit 27 that the disturbance yaw moment was triggered by a defect on wheel-individual drive 5 assigned to blocking wheel 9 and thus releases a compensation by compensator 29.

An active braking torque buildup MbComp is initially generated on intact wheel 7 which may superpose on a possibly already existing braking torque. The gradient of this braking torque buildup may consider the usual responsiveness of an average driver and, for example, chronologically control compensator 29 via the targeted retardation of the vehicle effectuated by brake 19 in such a way that the system initially, i.e., for example during the “reaction time” of the driver, controls the deceleration of wheel 7, which compensates for the disturbance yaw moment, completely automatically to then reduce the braking torque buildup and thus return more control to the driver.

During the deceleration process controlled by the compensator, the braking torque buildup is always supposed to take place in such a way that a sufficient lateral force potential is maintained on intact wheel 7 so that the vehicle continues to follow the steering input of the driver accordingly, albeit to a limited extent, since other wheel 9 cannot be released from the blocked state due to the defect on drive 5. The remaining lateral force potential may be secured in this case by monitoring the brake slip on intact wheel 7. A setpoint value for a maximally admissible brake slip may in this case depend on vehicle speed Vx, transverse acceleration Ay, as well as the braking force on the wheel, for example. Additionally, it is possible to resort to already known state variables present in the vehicle dynamics control system. If the brake slip exceeds the maximally admissible limiting value, further brake pressure buildup may be stopped and a wheel slip control may take place until a certain uncritical vehicle speed is fallen below. The setpoint value for the brake slip may be set in such a way that Fx_Comp is equal to Fx_Interference in the ideal case. If only partial compensation for the disturbance yaw moment is intended, the setpoint value for the brake slip may be selected to be accordingly lower.

Additionally or alternatively, compensation moment MbComp may be limited.

The compensation moment may alternatively also be generated using intact electric wheel drive 3, provided that a corresponding electric actuator potential is present, in that this wheel drive 3 is operated in generator mode in a retarding manner and in this way it may decelerate the wheel connected to it.

1-12. (canceled)

13. A device for compensating for a disturbance yaw moment in a vehicle having at least two wheel-individual drives, comprising:
a compensating arrangement configured to perform the following:
detecting an event which indicates a disturbance yaw moment of the vehicle and in which one wheel of the vehicle is excessively retarded due to a defect on a wheel-individual drive assigned to the wheel; and
effectuating a compensation yaw moment compensating for the disturbance yaw moment of the vehicle at least partially by retarding one or multiple of the other wheels of the vehicle in a targeted manner.

14. The device of claim 13, wherein the retardation to effectuate the compensation yaw moment is performed so that a force Fx_{comp} applied to the vehicle by the wheel(s) retarded in a targeted manner is essentially equal to a force Fx_{Interference} applied to the vehicle by the wheel retarded by the defective wheel-individual drive.

15. The device of claim 13, wherein the retardation to effectuate the compensation yaw moment is performed so that a brake slip on the retarded wheel(s) remains smaller than a predefinable limiting value.

16. The device of claim 13, wherein the retardation to effectuate the compensation yaw moment is performed by actuating at least one of a wheel-individual brake and a wheel-individual drive on the retarded wheel(s) operated in generator mode in a retarding manner.

17. The device of claim 13, wherein the event indicating a disturbance yaw moment of the vehicle is detected based on checking the affected wheel's ability to roll.

18. The device of claim 13, wherein the event indicating a disturbance yaw moment of the vehicle is detected based on checking the wheel-individual drive of the affected wheel.

19. The device of claim 13, wherein the event indicating a disturbance yaw moment of the vehicle is detected based on excessive retardation of the affected wheel which cannot be remedied.

20. The device of claim 13, wherein the targeted retardation of one or multiple other wheels of the vehicle is performed at a varying deceleration torque.

21. The device of claim 13, wherein the targeted retardation of one or multiple other wheels of the vehicle is performed according to an assumed responsiveness of a driver of the vehicle.

22. A vehicle, comprising:
multiple wheel-individual drives; and
a device for compensating for a disturbance yaw moment in a vehicle having at least two wheel-individual drives, including a compensating arrangement configured to perform the following:
detecting an event which indicates a disturbance yaw moment of the vehicle and in which one wheel of the vehicle is excessively retarded due to a defect on a wheel-individual drive assigned to the wheel; and
effectuating a compensation yaw moment compensating for the disturbance yaw moment of the vehicle at least partially by retarding one or multiple of the other wheels of the vehicle in a targeted manner.

23. The vehicle of claim 13, wherein the retardation to effectuate the compensation yaw moment is performed so that a force Fx_{comp} applied to the vehicle by the wheel(s) retarded in a targeted manner is essentially equal to a force FX_{Interference} applied to the vehicle by the wheel retarded by the defective wheel-individual drive.

24. A computer-readable medium having a computer program, which is executable by a processor, comprising:
a program code arrangement having program code for compensating for a disturbance yaw moment in a vehicle having at least two wheel-individual drives, by performing the following:
detecting an event which indicates a disturbance yaw moment of the vehicle and in which one wheel of the vehicle is excessively retarded due to a defect on a wheel-individual drive assigned to the wheel; and
effectuating a compensation yaw moment compensating for the disturbance yaw moment of the vehicle at least partially by retarding one or multiple of the other wheels of the vehicle in a targeted manner.
